(19) United States
(12) Patent Application Publication
(10) Pub. No.: US 2017/0116575 A1
(43) Pub. Date: Apr. 27, 2017

(54) SYSTEM AND METHOD FOR SKILL AND TIME MATCHING OF WORKERS TO JOBS IN A GEOGRAPHIC LOCALE

(71) Applicant: Scott DeGoler, Rancho Santa Fe, CA (US)

(72) Inventor: Scott DeGoler, Rancho Santa Fe, CA (US)

(21) Appl. No.: 14/923,305

(22) Filed: Oct. 26, 2015

(51) Int. Cl. G06Q 10/10

(52) U.S. Cl. CPC G06Q 10/1053

(57) ABSTRACT

A software enabled system and method for providing employees to hiring companies is disclosed. Using software running on networked computers, employee experience, skill, and availability, is matched to input requirements for such from hiring companies. Hiring companies can then choose an employee to fill a job at a geographic location and designated time and the chosen employee is provided the information on the job location, time and duration, so that they may arrive timely to perform the job for the hiring company.

### BACKGROUND OF THE INVENTION

1. Field of the Invention

The present invention relates generally to a system and method for a hiring-company to seek matching qualified workers for jobs available or coming available from the hiring-company. More particularly, the disclosed system and method relates to a computer-enabled service enabled by software running a server connected to a network accessible computer of a system provider, which matches workers possessing appropriate skills and qualifications to jobs immediately available or coming available which are proximate to a geographic locale where the worker will be located, during a time duration wherein the job is available at a specific geographic locale.

2. Prior Art

With the advent of wide use of the internet, job seekers looking for employment have moved their search for employment from printed media such as newspapers, to seeking employment by searching positions and jobs available which have been posted online for such job seekers to find and consider. Many larger companies have their own online presence, where company human resource personnel post positions available, in the hopes that qualified job seekers will find postings for positions for which the job seeker is qualified. Those job seekers who do find the posted job or position, will generally use the company website offering the job or position, to apply for such, whereafter appropriate company personnel will decide upon which job seeker to hire from candidates who have submitted applications.

This system works well for large companies who have the size to afford such a human resource department and website, so long as the company has known jobs and positions available or coming available, which are permanent or which will be available for a known time duration at a company location.

Smaller firms who lack the size and funding ability to for costly human resource personnel and employment advertising websites, have turned to other sources for seeking employees for temporary or long term employment. Such smaller firms have turned to online job advertising sites such as MONSTER, or to online publications for jobs and positions available such as CRAIGSLIST. This use of online publications works adequately for smaller firms who have a known job or position coming available in the future, for a known time duration, and wish to take the time to add someone to their payroll and resulting tax reports. However, unlike the dedicated human resource company-hosted sites of large firms, the small firm advertising for help is left with the task of gathering applicant information based on inquiries to their advertised job or position, qualifying applicants, and comparing qualified applicants to decide on a new employee. Further, they must gather the hired-employee's tax information and either include them as an employee of the small firm on tax documents, or report the hired person as self-employed to the government.

However, to firms needing employee help, both large and small, the current system of placing advertisements on company-hosted websites, or into online publications or job advertising sites, does not work well where the company requires a position or job to be filled immediately, such as the same day or in the very near future. For large firms, it can take days or weeks to move a job position from a known need, to an actual advertisement on a corporate or associated job site. Such does not work well to provide highly qualified job seekers for positions which come available the same day or same week, be they for overflow work or temporary employees to fill in for another employee. While larger firms may not need qualified workers on an immediate-need basis as often as smaller firms, such does occur with regularity. Jobs which could be filled by highly qualified job seekers for the immediate time frame, or short term, go unfilled and job seekers go unemployed and work goes undone which could have provided the large firm with profit and happy customers.

For smaller firms with only a few employees or even a hundred, such a need for a worker to fill an immediately open job position happens with great regularity. Smaller firms and solo business owners, frequently will have one of their few employees become unavailable, but still have work and tasks to be accomplished immediately, which will go undone without the ability to find highly qualified workers immediately, and for the time duration needed to continue accomplishing the work and tasks of the missing employee.

For example, a dentist may have an associate dentist working for a small firm, and either have an emergency or unanticipated patients which occupy the licensed staff and cause other patients to be unserved and rescheduled. Such breeds discontented patients who must reschedule, and a discontented professional staff who become overworked and must later deal with the created unhappy patients. Or, in such a small firm requiring medical professionals, should one professional become unavailable due to illness or other reasons, the patients for the small firm still must be serviced timely, and if they are rescheduled, cash flow will suffer by the lost business until the missing professional returns, or is replaced.

Consequently, for businesses from very large companies to very small firms, their needs for qualified workers on an immediate basis, such as the same day or the next day for example, are offered little if any options by the current state of online job seeking and advertising. There are few if any options or such businesses to find highly qualified workers, who are sufficiently proximate to the business, to be on site in short order, and, who have the qualifications, experience, required licenses, and the like, to provide the immediately needed services for the business.

As such, there exists an unmet need, for a system accessible over a network such as the Internet, for the immediate matching of job seekers with the appropriate experience, qualifications, licensing, and abilities and other measured or tracked traits, to fill an immediately-open job or position with a hiring-company needing a worker having such. Such a system should provide the ability for job seekers to input their requisite education, experience, licensing, and other information, and maintain such in a relational database of potential employees for firms having job positions requiring immediate filling by a qualified job seeker.

Such a system, in addition to inputting and maintaining a database of potential workers related to their respective education, job experience, talents, and qualifications, should also be able to match those qualified job seekers who meet hiring-company requirements, to the time and immediacy of the job position at a mutually agreed wage, and include in that calculation, the geographic location of the job position and a calculated time required for a potentially qualified job seeker to reach the location of the immediately available job opening. In this fashion immediately available jobs and positions with both large businesses, can be quickly filled with qualified and geographically proximate job candidates.

### SUMMARY OF THE INVENTION

The present invention is a computer and software enabled system, accessible by computer over a computer network such as the internet, which is configured to provide job seekers matching the qualifications for a job available immediately such as the same day or even the same hour, at a matched agreed-upon wage and to the location of the hiring-company requiring the matching job seekers within that time frame.

The system is enabled using software adapted for this time-immediate provision of qualified job seekers to the geographic location of a hiring-company, requiring the employee with the appropriate skills and qualifications. The system herein, once job seekers have registered appropriate identification, allows them to access the system as subscribing employees to both input their qualifications and availability, and to seek and accept jobs matching those qualifications, which are available in the time frame and duration the subscribing employee has indicated is available.

Hiring-companies who provide required identification and administrative information are also allowed subsequent access to the system to post available jobs, the time when the job was first offered and when it must be performed, and the expected duration of the job position needed. A hiring-company will also be provided information to authorize the system provider to automatically receive payments such as an authorization to receive funds from the company bank account or a credit card or other means, to pay any subscribing employees who perform work at the hiring-company for the system provider who will be the employer. Payment will be made to subscribing employees by the system provider using funds received from the hiring-company. The system provider will thus pay the subscribing employee for the work, and pay the appropriate taxes for each subscribing employee as well as file the employer tax forms.

Matching of subscribing employees to jobs available from a hiring-company will be handled by software running on the computer system of the system provider. The software will match the job requirements uploaded by subscribing hiring-company, such as skills, education, experience, license requirements, and a wage to be paid for the hourly time an employee performs the job, to the related data held in a database of subscribing employees as to the matching criteria to a subscribing employee possesses to the subscribing hiring-company requirements.

Additionally considered in making a match and providing the subscribing hiring-company with a choice of one or more subscribing employees will be the location of the hiring-company, ratings and reviews of the hiring-company from previously hired employees, the time the employee is needed, the wage offered, and the duration the employee is needed. This will be compared with the current location of the subscribing employees matched to the job, the time durations each is available and based on the time of arrival needed by the subscribing hiring-company, a wage a subscribing employee has agreed to, a calculation of the duration of time each matched subscribing employee will take to arrive at the location of the job for a subscribing hiring-company.

In this fashion, available qualified subscribing employees can be matched to hiring-company requirements, and dispatched in minutes if required to the location of the job for the subscribing hiring-company. Since as noted herein, the payment and taxes and government filing requirements for each subscribing employee hired by a hiring-company are made by the system provider as employer, the hiring-company need only worry about putting the chosen subscribing employee on the job the minute they arrive. The subscribing employee will not need to worry about being paid since each subscribing hiring-company, has in advance made payment arrangement with the system provider for payment by them of the subscribing employees.

Thus, the system herein can fill jobs for hiring-companies in minutes or hours, which formerly went unfilled, and subscribing employees and subscribing hiring-companies are also better served. With respect to the above description, before explaining at least one preferred embodiment of the herein disclosed employee and hiring-company matching system in detail, it is to be understood that the invention is not limited in its application to the details of construction and to the arrangement of the steps in the following description or illustrated in the drawings. The invention herein described is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for implementation of a system for worker and job requirement matching in real time and for carrying out the several purposes of the present disclosed system. It is important, therefore, that the claims be regarded as including such equivalent construction and methodology insofar as they do not depart from the spirit and scope of the present invention.

It is an object of the invention to provide an Internet-based software-enabled system for real time matching of subscribing employee qualifications and skills to job requirements of a subscribing hiring-company.

It is a further object of this invention to provide such a system which is able to match one or a plurality of subscribing employees to the job requirements of a subscribing hiring-company which may be minutes or hours or days from being needed.

It is an additional object of this invention to provide such a system which takes into consideration persona-matching of the employees, based on results to a test compared to national norms for the job requirements as an additional element for hiring-company review and choice.

It is yet another object of this invention to include current employee locations and time duration to arrival at a job location as an additional element for making a choice.

Further objectives of this invention will be brought out and discerned by those skilled in the art through a reading of the following part of the specification wherein detailed description is provided for the purpose of fully disclosing the invention, without placing limitations thereon.

### BRIEF DESCRIPTION OF DRAWING FIGURES

FIG. 1 is a block diagram of a general flow of the disclosed system depicting a flow of information from and to subscribing employee job seekers.

FIG. 2 depicts a block diagram of a general flow of the disclosed system depicting steps and a flow of information to and from a subscribing hiring-company, concerning jobs available and qualified subscribing employees able to perform those jobs in the time frame outlined.

FIG. 3 depicts a block diagram of a general flow of the disclosed system herein for the system provider in matching one or a plurality of subscribing employees to the system, to a hiring-company-input job, and providing the hiring-company with information allowing a choice by the hiring-company or system if so arranged.

FIG. 4 depicts a block diagram of a preferred flow of the system herein managed by the software running on the networked computers of the system provider to track and manage the workday of the subscribing employee with input from both the subscribing employee and hiring company to adapt for scheduling.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

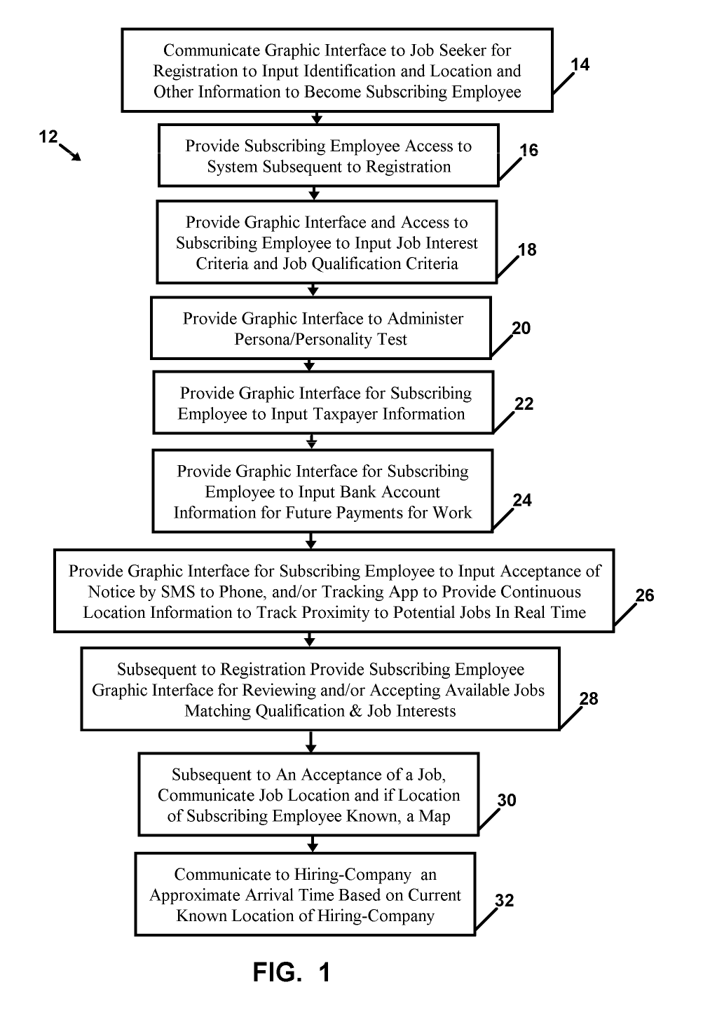

Now referring to drawings of FIGS. 1-3, which generally depict a flow of the system herein, in FIG. 1 there is depicted a block diagram 12, of a job seeker who is new to the system, becoming a subscribing employee. Thereafter they may use their granted access to the system, to input information for them to become a subscribing employee. In a first step 14, the job seeker will be provided a graphic interface to input their identification, location, and other administrative information needed to register them as subscribing employees to the system, and to establish their identity in the database of subscribing employees.

Thereafter as a registered subscribing employee they are allowed access to the system 16 over the Internet using their remote computing device such as a personal computer, smart phone, pad computer or other device having a video display capable of depicting the graphic interfaces, inputting required information thereto and using wired or wireless transmission for communication thereof with the system provider over a network such as the Internet.

With their access to the system herein, subscribing employees will be given access to a graphic interface allowing them to input their job preferences, their qualifications based on experience and education, and other criteria 18 used by the system to match subscribing employees to available jobs.

In another particularly preferred step herein, each subscribing employee is also given a persona test 20 during registration. A graphic interface is provided for the subscribing employee to input responses to a group of easily answered questions directed to the subscribing employee.

Based on the respective subscribing employee responses input to the presented graphic interface, to the presented questions in the persona rating test 20, a persona rating score is subsequently determined, for subscribing user, relative to each subsequent available job, based on known national norms of persona test question answers, as related to each job description or profession. The persona rating score may thereafter matched with appropriate skills and subsequently added as a component in addition to a score for the subscribing employee qualification skill list, to better match those with experience skills.

The persona score will as noted employ subscribing employee answers to questions presented on a graphic interface, to score that subscribing employee with the persona score as it relates to any subsequent job for which the subscribing employee may be considered. This persona score can be used both to match subscribing employees to available jobs from subscribing employers, as well as to provide the hiring companies a secondary metric to match presented candidates for a job, to the best persona for that job based on the industry and job requirements input by the subscribing employer.

An example of a persona rating is the well known Sixteen Personality Factor Questionnaire, also called the 16PF. Using the answers to questions presented the test taker yields scores of sixteen different personality traits, including dominance, vigilance, and emotional stability. As is also well known with this widely used test, these sixteen factors can be combined to express five “global factors” of personality including emotional stability, conscientiousness, agreeableness, extraversion, and openness to experience.

The system herein using answers input by the subscribing employee, to the persona test questions presented in the graphic interface 20, and software adapted for the calculation by comparison of each input answer in relation to a database of personality traits relating to each answer, determines a trait score for each one of a chosen plurality of personality traits, where a higher trait score indicates the subscribing employees more strongly has such a trait, and a lower trait score indicates the trait is lacking. Using software adapted to the task running on the system providers computers, the trait score for each personality trait, for each subscribing employee, is compared to a database of a desired high or low trait score for each job description and job qualification. Thereafter for example, a sum of high scores for undesirable personality traits can be subtracted from a sum of high scores for desirable personality traits for the job posted by the hiring company, and a persona score can by ascertained for each posted job for which the subscribing employee applies. This persona score is depicted in an association with each respective subscribing employee communicated in a listing communicated to the hiring company, for the job which was posted by that hiring company.

Thus, subscribing employees with high trait scores for desirable personality traits which are desirable for the hiring-employer input job description and job qualifications, will have a high persona score for that job which may be provided to allow the hiring company to use in making a decision. Such might prevent the hiring of a subscribing employee for a job where their qualifications match but their persona score shows they would not be a good fit for the job, thereby saving the subscribing employee from a job they will probably dislike. Such trait scores and persona scores can also be employed by the system provider, to match subscribing employees to jobs which they may not have considered as something they might like.

In order to eliminate the time required for a hiring-company to observe government employee tax and reporting requirements, each subscribing employee will also input their taxpayer information 22. This will allow the system provider to act as the hiring-company and pay taxes for jobs performed, and file the required tax information with local, state, and federal agencies.

Subscribing employees will also be asked to input their banking information 24 using the graphic interface communicated to their computing device. This information is later employed to make direct deposits to the subscribing employee bank for work performed.

The system as herein described, will match employee skills, education, licensing, experience, and other criteria, as well as the current location of the subscribing employee, and their time availability, to match subscribing employees to available jobs. The subscribing employee may receive notice on a smartphone or portable device, and input acceptance 26, or use access to the system from a remote location to review jobs and accept 28

For subscribing employees accepting a job, where the system has access to their location using an application loaded to a portable device such as a smartphone, the location of the job can be communicated along with a map from their current known location to the hiring-company 30. If their location is not known, a map can be provided from their known home which was originally input.

Finally, subsequent to the subscribing employee acceptance, the subscribing hiring-company may be notified electronically of the subscribing hiring-company who is coming and their estimated arrival time based on a known location 32 which would be most important if the job is required to start in minutes or less than a few hours.

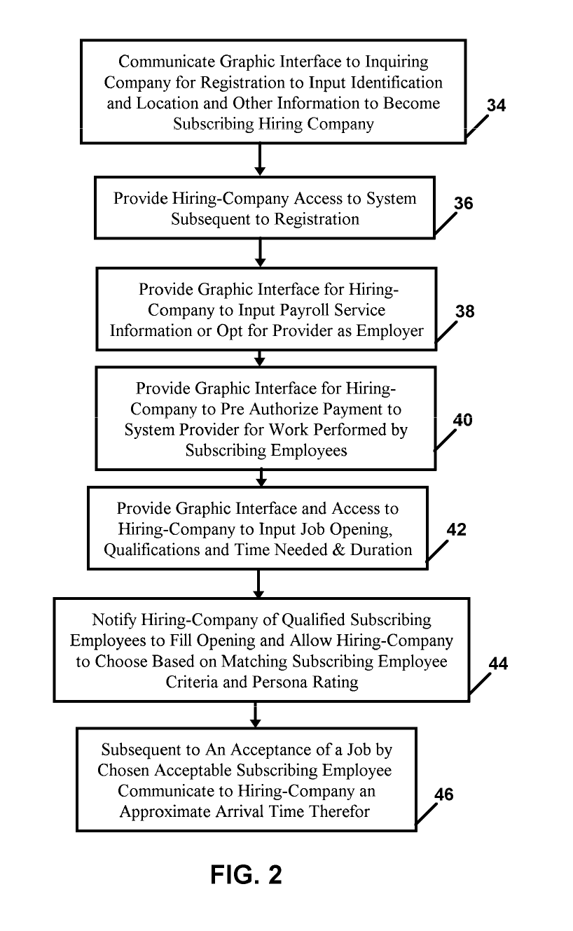

As shown in FIG. 2, each firm must also register as subscribing hiring-company by communicating with the system provider website using an electronic device capable of such and inputting identification, location, and other information 34. Thereafter, the firm as a subscribing hiring-company, is provided user access to the system of the system provider.

Generally, prior to allowing a subscribing hiring-company to seek and provide work for subscribing employees, the hiring-company is provided with input screens to input acceptance of any legal or contractual requirements of the system provider and that the system provider will act as employer of any subscribing employee provided work by the subscribing-company. Thereafter, in a significant benefit of the system herein, the system provider will act as the employer and pay each subscribing employees for any work done for any subscribing-company. In this fashion, each subscribing-company is provided significant savings in time and money by the elimination of the constraints and requirements generally associated with adding a new employee to their system on one or multiple occasions. Such will significantly enhance the system and encourage each hiring-company to seek a subscribing employee for tasks at hand immediately or at a predicted time and duration in the future.

Each hiring-company will also be provided with a graphic interface for input of preauthorization for payment to the system provider by inputting credit card or banking or information authorizing other means for payment by a hiring-company to the system provider. Thereafter, the hiring-company is provided with access to the system to input immediate or upcoming jobs for which the subscribing hiring-company requires workers 42. The input job information will include all criteria required for the job at hand such as education requirements, experience, licenses, etc. as well at the immediacy of the impending job such as in minutes hours or days. Further input will be the anticipated duration of the job.

Thereafter as described herein, the system herein, employing software running in electronic memory of computers of the system provider, will match the hiring-company input requirement criteria and agreed wage for work to be performed, to the skills and input criteria from subscribing employees for work sought or preferred. Each hiring-company will be notified of a match 44 of one or a plurality of subscribing employees. The match may be a listing of subscribing employees or more preferably a listing of subscribing employees and a respective associated match rating or each.

The match rating associated with each subscribing employee communicated in a match 44 can be calculated using a qualification match score generated by software adapted to match from a database of individual input subscribing employee criteria 18 for each subscribing employee in the match 44, to the input job opening and qualification criteria 42, combined with a availability match score of the subscribing employees in the match 44 for the times required to perform the work input to be performed 40.

For example, the employee qualifications as to education and degrees, work experience, licenses, qualification certificates, proximity to the job determined by their address, all input in the subscribing employee criteria 18, would be matched to those same requirements input by the hiring company to achieve the qualification match score. An availability match score is determined by software running on the system which will match the times the subscribing employee is available for work, to the times input by the hiring company for the job. A higher availability score is given to those subscribing employees who are more or most available during the times of the job input by the hiring company.

For example the match rating or match score can be an alphanumeric score between 1 and 10 which can be a sum of the qualification match score of qualification criteria 42 to input employee criteria 18, which varies between 1 and 6 points, where 6 would be a perfect match and 1 would be a partial match, and the availability score which would vary between 1 and 4 points where 4 points would be an employee available at all times required, and 1 point would be an employee available for only a part of the time required. Alternatively, the match rating, can be presented as separate respective scores for each of the qualification score, and the availability score, rather than a sum score, to allow the hiring company to rate one higher than the other. Such would allow hiring companies the choice to lean more on availability or qualifications if they wish rather than a sum score.

Additionally provided to each hiring-company in a preferred step, in the graphic interface notifying the hiring-company of subscribing employees 44, will be the provision respective alphanumerical persona rating, for each respective subscribing employee, as it relates to the job or work identified by the subscribing employer to be performed for the subscribing employer. The persona rating as noted herein, is achieved using the results of the persona test 20 given each subscribing employee, and a numerical rating of a relative match of the persona of each respective subscribing employee, to the input job opening and qualification criteria 42 input by the hiring company. This can be a numerical rating between 1 and 5, wherein a score of 5 shows the persona of the respective subscribing employee is an exceptional match to the job opening and qualification criteria 42, and a score of 1 would show a poor persona rating for such.

In this fashion, the hiring company is notified of the respective qualified subscribing employees 44 to choose from, and in the graphic interface presented for a choice, the hiring company is also given a match rating and a persona rating for each prospective subscribing employee presented to the hiring company for choosing. This allows the hiring company to choose based on the hiring-company's view of the most important qualities for the work, from a score for qualifications, availability, as well as a score for a persona match to the job at hand. Thus the hiring company can discern what of the three qualities is most suited to their need. Over time hiring companies may discern a pattern for matching to their jobs based on previous experiences, and use the three provided scores based on experience to choose.

Using the graphic interface notifying the hiring company of the available subscribing employees along with the match rating and persona rating of each, the hiring-company can then make and input a choice of a subscribing employee 44 for the system provider to notify and provide information concerning the work to be performed.

The hiring-company, subsequent to an input of an acceptance of a job by a chosen subscribing employee, based on the current location of the chosen subscribing employee, traffic, and other travel calculations, can be informed electronically of the approximate arrival time at the site of the job 46 of the chosen subscribing employee. Because the hiring-company need not deal with payroll and tax considerations of the arriving subscribing employee, they may be immediately put to work by the hiring-company upon arrival saving the hiring-company time and costs of employee acquisition, and saving the subscribing employee the hassle of filling out employer forms as well as any concerns of being paid since the system provider has arranged such in advance and will provide payment upon work completion. This significant savings in time and costs and concerns to both the hiring-company and subscribing employee will encourage widespread use of the system herein yielding jobs for subscribing employees and increased work output and profits for each subscribing hiring-company.

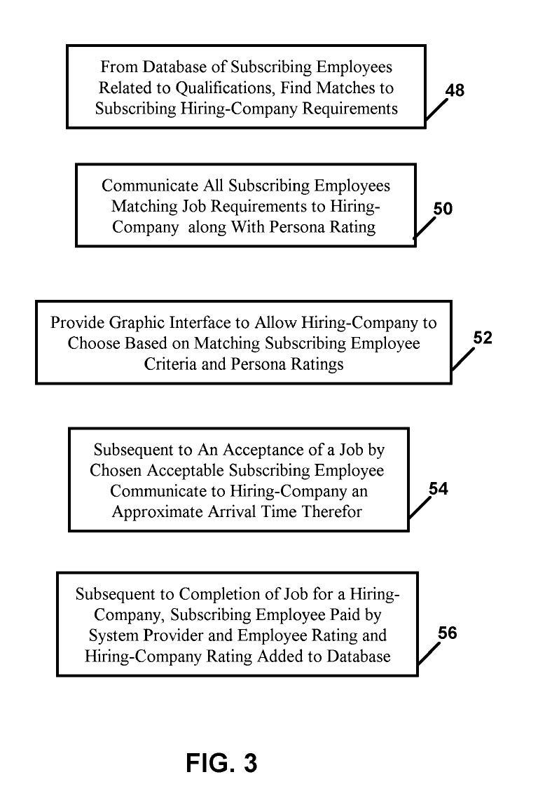

FIG. 3 generally depicts a flow chart of the system provider in implementing the system herein as described above and in some cases reiterates steps noted above. As noted once each subscribing employee and hiring-company has input the information noted above using a software application and/or communicated graphic interfaces from the system provider, using the relational database of qualifications and other criteria of subscribing employees, software adapted for comparison of such to hiring-company requirements will match one or a plurality of subscribing employees to the respective job requirements of a hiring-company 48.

Thereafter the system provider using software adapted to the task of electronic digital communications will communicate a listing of matching subscribing employees to the hiring company 50, along with a persona rating. In this communication or subsequent thereto the hiring-company will be provided an interface to input a choice of a subscribing-employee 52 from those communicated as matching. As noted above, the chosen subscribing employee will then be notified electronically concerning the location of the hiring-company and time and duration of the job so as to enable them to arrive in a timely fashion to work. The hiring-employer will be notified that the respective chosen subscribing employee has accepted the assignment of the job and if the software on running on the system which is adapted to calculate arrival time can predict such, the hiring-employer will be also notified of an approximate arrival time of the chosen subscribing employee 54.

In a final step subsequent to the performance of work for a chosen company by a subscribing employee, the system provider employing software running on the system adapted to handle subscribing employee payment to the designated bank account and to calculate and withhold taxes and file appropriate forms, will communicate payment to the subscribing employee, and subsequent to any input from the subscribing employee or hiring-company, input to the database ratings of each as to the other which may be employed in the future by subscribing employees viewing a hiring-company and by a hiring-company reviewing a respective subscribing employee 56. The handling of payment of the subscribing employee by the system provider as noted, allows the system herein to provide enhanced utility to both the hiring-company and subscribing employee thereby encouraging future use by both. The respective ratings by the subscribing employee of a hiring-company and by a hiring-hiring company of a chosen subscribing employee, when posted for view in the database will also enhance the ability of both to choose in future use of the system herein.

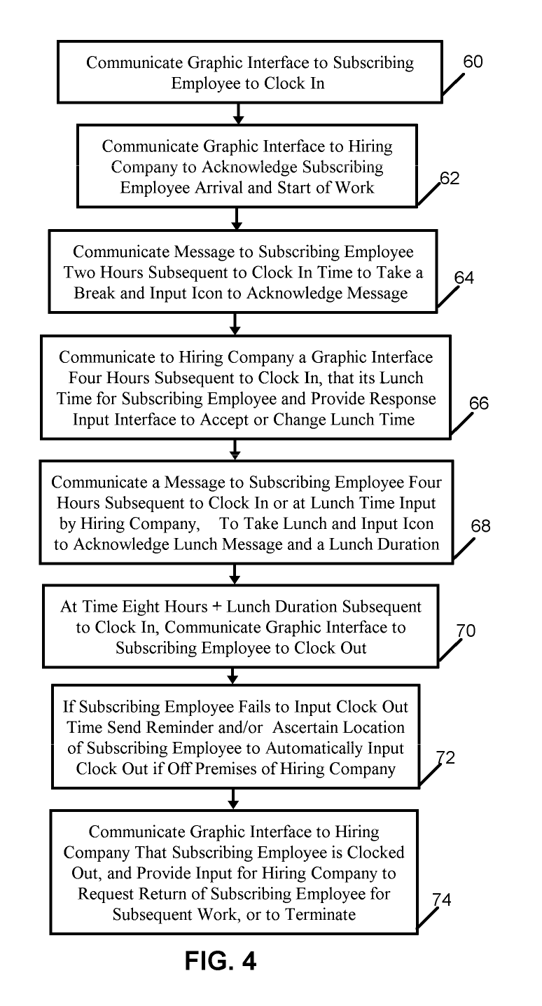

An important aspect of the system herein and it is preferred that in all modes that subscribing employees working at a hiring company location, are provided reminders and acknowledgment of such concerning their workday, to make sure that all state and federal laws concerning employment are followed. As Shown in FIG. 4, in a preferred mode of the system herein, prior to or on a determined arrival to work, the system provider will communicate to a computing device of the subscribing employee, a graphic interface allowing the subscribing employee to input a clock in time 60. The input can be a simple touch screen icon which will transmit to the software running on the server of the system provider, an acknowledgment of the subscribing employee they are beginning work. Concurrently, a graphic interface can be sent to the hiring company to allow them by a simple touch or other input icon, to acknowledge they are aware that the subscribing employee is on the premises 62. A response from the hiring company can be optional because there may be times an authorized person from the hiring company may not be available to respond.

In order to fulfill state and federal requirements for working hours and required breaks, it is particularly preferred that the system herein communicate break and lunch reminders to the subscribing employee on a job site. To that end, substantially two hours subsequent to the input by the subscribing employee, a graphic interface is communicated to their computing device, which is preferably a smartphone, that it is time for a break, and providing an icon or other interface to communicate and acknowledgment of the message 64. Of course this can, and in most cases, be communicated multiple times in a full day of work because most states require two breaks and a lunch.

Thereafter, in order to make sure the subscribing employee remembers to take a required lunch break, the subscribing employee will be provided graphic interface message to do so. However, first it may be preferable to communicate a message in a graphic interlace to the hiring company, that lunch is scheduled for the subscribing employee, and giving the hiring company a graphic input to acknowledge and agree, or to indicate determined time for a lunch based on current workload 66. Subsequent to any such input by the hiring company, a message and graphic interface allowing for a simple touch or other input acknowledging receipt of the lunch message and time, is communicated to the smartphone or other computing device of the subscribing employee 68.

In order to track the subscribing employees time at work at the hiring company, software running on the computers or service for the system provider, will track the clock in time communicated from the subscribing employee, and prior to or at substantially eight hours subsequent to the communicated clock in time from the subscribing employee, a graphic interface will be communicated to the computing device of the subscribing employee, to input an acknowledgment of clocking out from work 70. The subscribing employee may either touch an icon on the graphic interface to send the clock out time to the software running on the computers of the system provider, or other clock out times might be positioned or input on the graphic interface provided for input of clock out 72. In the event no signal is received from the subscribing employee within a determined amount of time, such as ten minutes, the system can retransmit the clock out interface, or, using the GPS location from the smartphone or other portable computer of the subscribing employee, ascertain if the subscribing employee has left the premises of the hiring company, and clock the subscribing employee out.

Subsequent to a clock out determination input or ascertained from the subscribing employee, a graphic interface is preferably communicated to the computing device of the person at the hiring company responsible, to first inform the hiring company the subscribing employee has clocked out, and to provide a graphic interface to allow the hiring company, to input a request to have the subscribing employee return for an additional work shift, or to terminate the work by the subscribing employee 74. The graphic interface can for example provide touchable or clickable graphically depicted buttons or icons, which will input either one or both of an acknowledgment of the message, and a response to send the subscribing employee back, or terminate. This is much like the graphic interfaces communicated in other instances herein where by providing simple touch or click icons or buttons or the like, a quick response is enabled, and thus more likely to happen since the responder be they the hiring company or the subscribing employee are given an easy way to do so.

Thereafter, based on the inputs from the subscribing employee as to time on the job, and the hiring company, payment for hours worked can be initiated by the system provider to the subscribing employee, and the subscribing employee can be directed to return for work again that the hiring company, wherein the steps herein will substantially repeat, or the subscribing employee can be noted as terminated, and designated to the system database relating to that subscribing employee that they are available for new work.

While all of the fundamental characteristics and features of the software enabled real time matching of employees to hiring-company-offered jobs of the system herein have been shown and described herein, with reference to particular embodiments thereof, a latitude of modification, various changes and substitutions are intended in the foregoing disclosure and it will be apparent that in some instances, some features or steps in the invention may be employed without a corresponding use of other features or steps without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A software-enabled method for matching workers, to hiring-company offered jobs, in real time using computers with electronic memory of a system provider running the software and which are engaged with a wide area network, comprising the steps of:
communicating a graphic interface to a job seeker for input registration information for storage in said electronic memory of said system provider and thereby register as a subscribing employee;
communicating a graphic interface to said subscribing employee to input job qualifications of said subscribing employee for storage in said electronic memory in a database in rebating to each respective subscribing employee;
communicating a graphic interface for a hiring company to input registration information for storage in said electronic memory in a relation to each said hiring company;
providing a graphic interface to each hiring company to input a job opening, job qualifications for said job opening, and a time duration of said job opening;
providing a graphic interface accessible by said subscribing employees to input a choosing of a respective job opening and to input a time of availability during said time duration of said job opening;
comparing said qualifications input by said subscribing employee to said job qualifications input by said hiring company and determining a qualification match score;
comparing said time of availability of said subscribing employee to said time duration of said job opening input by said hiring company to ascertain an availability score;
providing a graphic interface accessible by said hiring company a listing of each said subscribing employee choosing said job opening input by said hiring company;
in said listing of each said subscribing employee provided said hiring company, providing a respective said qualification match score and respective said availability score for each said subscribing employee in said listing; and
communicating a graphic interface for said hiring company to input a chosen said subscribing employee from said listing; and
communicating to said chosen subscribing employee they have been chosen by said hiring company for said job opening.

2. The software-enabled method for matching workers of claim 1 including the steps of:
providing a graphic interface to said chosen subscribing employee to input an acceptance of said job opening;
communicating to said hiring company a confirmation of said acceptance of said chosen subscribing employee; and
based on a determined location for said chosen subscribing employee, and a location for said job opening, calculating an arrival time for said chosen subscribing employee and communicating said arrival time to said hiring company.

3. The software-enabled method for matching workers of claim 1 including the steps of:
communicating a graphic interface containing questions defining a persona test to each respective subscribing employee;
recording responses to each said questions of each respective subscribing employee;
based on said responses, determining persona trait scores fore each respective said subscribing employee and storing said persona trait scores in a database in relation to each respective subscribing employee;
determining a persona score for each said subscribing employee based on a desirability of each of their respective persona trait scores for each said job qualification for said job opening; and
including a respective said persona score in relation to each respective subscribing employee in said listing.

4. The software-enabled method for matching workers of claim 2 including the steps of:
communicating a graphic interface containing questions defining a persona test to each respective subscribing employee;
recording responses to each said questions of each respective subscribing employee;
based on said responses, determining persona trait scores fore each respective said subscribing employee and storing said persona trait scores in a database in relation to each respective subscribing employee;
determining a persona score for each said subscribing employee based on a desirability of each of their respective persona trait scores for each said job qualification for said job opening; and
including a respective said persona score in relation to each respective subscribing employee in said listing.

5. The software-enabled method for matching workers of claim 1 including the steps of:
communicating a rating graphic interface to said chosen subscribing employee, to input a hiring company rating for said hiring company for which said chosen subscribing employee worked; and
allowing said subscribing employees to access to review said hiring company rating from said chosen subscribing employee.

6. The software-enabled method for matching workers of claim 1 including the steps of:
communicating a rating graphic interface to said hiring company to input an employee rating for said chosen subscribing employee; and
allowing other said subscribing companies to review said employee rating of said chosen subscribing employee.

7. The software-enabled method for matching workers of claim 5 including the steps of:
communicating a rating graphic interface to said hiring company to input an employee rating for said chosen subscribing employee; and
allowing other said subscribing companies to review said employee rating of said chosen subscribing employee.

8. The software-enabled method for matching workers of claim 4 including the steps of:
communicating a rating graphic interface to said chosen subscribing employee, to input a hiring company rating for said hiring company for which said chosen subscribing employee worked;
allowing said subscribing employees to access to review said hiring company rating from said chosen subscribing employee;
communicating a rating graphic interface to said hiring company to input an employee rating for said chosen subscribing employee; and
allowing other said subscribing companies to review said employee rating of said chosen subscribing employee.

9. The software-enabled method for matching workers of claim 2 including the steps of:
communicating to said subscribing employee a graphic interface allowing said subscribing employee to signal a clock-in time of starting work at said location for said job opening;
at a time calculated for a break in work subsequent to said clock in time signaled by said subscribing employee, communicating a graphic interface to said subscribing employee at said location for said job opening a break message indicating a time has arrived to take a break along with an input on said graphic interface for said subscribing employee to acknowledge receipt of said break message;
at a time subsequent to said clock in time calculated for a lunch break, communicating a graphic interface to said subscribing employee with a second message indicating said time to take said lunch break, along with an input on said graphic interface for said subscribing employee to acknowledges said second message;
at or before a time calculated to be eight hours subsequent to said clock in time, communicating a graphic interface to said subscribing employee with an input thereon for said subscribing employee to acknowledge a clock-out time; and
calculating a payment due said subscribing employee based on the time between said clock-in time and said clock-out time, minus a duration of said lunch break, and tendering said payment due said subscribing employee.

10. The software-enabled method for matching workers of claim 4 including the steps of:
communicating to said subscribing employee a graphic interface allowing said subscribing employee to signal a clock-in time of starting work at said location for said job opening;
at a time calculated for a break in work subsequent to said clock in time signaled by said subscribing employee, communicating a graphic interface to said subscribing employee at said location for said job opening a break message indicating a time has arrived to take a break along with an input on said graphic interface for said subscribing employee to acknowledge receipt of said break message;
at a time subsequent to said clock in time calculated for a lunch break, communicating a graphic interface to said subscribing employee with a second message indicating said time to take said lunch break, along with an input on said graphic interface for said subscribing employee to acknowledges said second message;
at or before a time calculated to be eight hours subsequent to said clock in time, communicating a graphic interface to said subscribing employee with an input thereon for said subscribing employee to acknowledge a clock-out time; and
calculating a payment due said subscribing employee based on the time between said clock-in time and said clock-out time, minus a duration of said lunch break, and tendering said payment due said subscribing employee.

11. The software-enabled method for matching workers of claim 7 including the steps of:
communicating to said subscribing employee a graphic interface allowing said subscribing employee to signal a clock-in time of starting work at said location for said job opening;
at a time calculated for a break in work subsequent to said clock in time signaled by said subscribing employee, communicating a graphic interface to said subscribing employee at said location for said job opening a break message indicating a time has arrived to take a break along with an input on said graphic interface for said subscribing employee to acknowledge receipt of said break message;
at a time subsequent to said clock in time calculated for a lunch break, communicating a graphic interface to said subscribing employee with a second message indicating said time to take said lunch break, along with an input on said graphic interface for said subscribing employee to acknowledges said second message;
at or before a time calculated to be eight hours subsequent to said clock in time, communicating a graphic interface to said subscribing employee with an input thereon for said subscribing employee to acknowledge a clock-out time; and
calculating a payment due said subscribing employee based on the time between said clock-in time and said clock-out time, minus a duration of said lunch break, and tendering said payment due said subscribing employee.

12. The software-enabled method for matching workers of claim 8 including the steps of:
communicating to said subscribing employee a graphic interface allowing said subscribing employee to signal a clock-in time of starting work at said location for said job opening;
at a time calculated for a break in work subsequent to said clock in time signaled by said subscribing employee, communicating a graphic interface to said subscribing employee at said location for said job opening a break message indicating a time has arrived to take a break along with an input on said graphic interface for said subscribing employee to acknowledge receipt of said break message;
at a time subsequent to said clock in time calculated for a lunch break, communicating a graphic interface to said subscribing employee with a second message indicating said time to take said lunch break, along with an input on said graphic interface for said subscribing employee to acknowledges said second message;
at or before a time calculated to be eight hours subsequent to said clock in time, communicating a graphic interface to said subscribing employee with an input thereon for said subscribing employee to acknowledge a clock-out time; and
calculating a payment due said subscribing employee based on the time between said clock-in time and said clock-out time, minus a duration of said lunch break, and tendering said payment due said subscribing employee.

13. The software-enabled method for matching workers of claim 11 including the steps of:
prior to communicating said second message to said subscribing employee indicating said time to take said lunch break, first communicating a graphic interface to said hiring company allowing an input of a response from said hiring company designating said time to take said lunch break.

14. The software-enabled method for matching workers of claim 12 including the steps of:
prior to communicating said second message to said subscribing employee indicating said time to take said lunch break, first communicating a graphic interface to said hiring company allowing an input of a response from said hiring company designating said time to take said lunch break.

15. The software-enabled method for matching workers of claim 11 including the steps of:
subsequent to said clock-out time, communicating a graphic interface to said hiring employee, a message informing said hiring employee of said-clock out time of said subscribing employee along with an input for said hiring company to either request said subscribing employee return for more work, or to terminate said subscribing employee.

16. The software-enabled method for matching workers of claim 12 including the steps of:
subsequent to said clock-out time, communicating a graphic interface to said hiring employee, a message informing said hiring employee of said-clock out time of said subscribing employee along with an input for said hiring company to either request said subscribing employee return for more work, or to terminate said subscribing employee.

17. The software-enabled method for matching workers of claim 13 including the steps of:
subsequent to said clock-out time, communicating a graphic interface to said hiring employee, a message informing said hiring employee of said-clock out time of said subscribing employee along with an input for said hiring company to either request said subscribing employee return for more work, or to terminate said subscribing employee.

18. The software-enabled method for matching workers of claim 14 including the steps of:
subsequent to said clock-out time, communicating a graphic interface to said hiring employee, a message informing said hiring employee of said-clock out time of said subscribing employee along with an input for said hiring company to either request said subscribing employee return for more work, or to terminate said subscribing employee.
